(19) United States
(12) Patent Application Publication
(10) Pub. No.: US 2009/0144015 A1
(43) Pub. Date: Jun. 4, 2009

(54) Apparatus And Method for Monitoring A Heating System

(75) Inventor: Gerard Bedard, Manchester, NH (US)

Correspondence Address: THOMAS P. GRODT ATTORNEY AT LAW, 4 PEABOY ROAD ANNEX, DERRY, NH, 03038, US

(73) Assignee: Creative Inspirations by Meryle, LLP, Manchester, NH (US)

(21) Appl. No.: 12/050,250

(22) Filed: Mar. 18, 2008

Related U.S. Application Data
(60) Provisional application No. 60/992,123, filed on Dec. 4, 2007.

(51) Int. Cl. G01K 13/00

(52) U.S. Cl. 702/130

(57) ABSTRACT

An apparatus and method for measuring the efficiency of a heating system in which the temperature of the flue, or stack, is measured during a heating cycle and data collected to show the elapsed time and maximum temperature achieved. This data is compared to predetermined limits and if the elapsed time and/or the maximum temperature exceeds the predetermined limits, an error message is generated that may be video, audio, and/or an email sent to a predetermined email address. Other statistics may be generated and temperature data from more than one heating cycle may be aggregated together.

### BACKGROUND OF THE INVENTION

1. Field of the Invention

This invention generally relates to an apparatus and method for monitoring a heating system and in particular, to an apparatus and method for monitoring the rate of change of the temperature of the heating system and deriving various parameters therefrom.

2. Description of Related Art

Heating systems, such as in a house or office, or a heating system for use in industrial applications typically are adjusted for efficiency and serviced by qualified service technicians. These systems are adjusted and various parameters are recorded and compared to predetermined values and when the heating system parameters have been adjusted to within a predetermined range, the system is declared ready for use. Typically the service technicians must calibrate their equipment, analyze the gas composition of the exhaust stack, and/or use predetermined values in their adjustments.

Often the adjustment of these heating systems are expensive, particularly if exhaust gases are analyzed, and do not account for any change of these parameters that may change during the course of a heating cycle and that be more indicative of a lack of efficiency of a heating system.

Accordingly, it would be advantageous to provide an apparatus and method that could provide for real time data analysis, rate of change data, does not need to be calibrated and does not have to analyze exhaust gases.

### SUMMARY OF THE INVENTION

An apparatus for measuring the efficiency of a heating system including a flue and thermostat that includes a temperature sensor thermally coupled to the flue and that is able to measure the external temperature of the flue and to provide temperature data to a receiver. The receiver receives the temperature data and provides the temperature data to a temperature analysis module. The temperature analysis module receives the temperature data and stores the temperature data along with a time stamp indicating when the data was sensed and recorded. The temperature analysis module further also analyzes the time and temperature data and compares it to a predetermined error limit. If the time and temperature data exceeds the error limit, the module triggers an error alarm that may be an audio signal, a video, or it may generate an email and send it to a predetermined email address. In general, the temperature sensor may be either wired or wirelessly connected to the receiver and also the temperature sensor may be a direct sensor, i.e., physically attached to the flue, or remotely sense the temperature by sensing infrared radiation given off by the flue. The time data may be provided by a time stamp generator located in the temperature analysis module, the receiver, or the temperature sensor/transmitter itself.

The temperature analysis module may also store data from a number of heating cycles and perform statistical analysis on the stored data, for example by finding the mean and standard deviation of the data. The temperature analysis module may contain a microprocessor, memory and assorted glue logic and registers that are necessary for the proper operation of the system.

In addition, a method for measuring the efficiency of a heating system is described that includes detecting when the heating system turns on, sensing the temperature of the flue and providing temperature data, recording the temperature data and a time data associated with said temperature data to form time-temperature data. The method is then to detect the maximum temperature of the flue, record the maximum temperature of the flue, and determine the elapsed time from the heating system turning on until the maximum temperature was reached. The method includes recording the elapsed time associated with the maximum temperature, comparing the elapsed time and maximum temperature with a predetermined limit and in the event that the elapsed time, the maximum temperature, or both exceed the predetermined limit, record the maximum temperature and elapsed time in a not-in-limit memory and master storage memory. The method includes comparing the number of entries in the not-in-limit memory and compare to a predetermined limit, and in the event that the number of entries in the not-in-limit memory exceeds the predetermined limit, generate an error signal. In the event that neither the elapsed time or the maximum temperature exceed the predetermined limit, record the maximum temperature and elapsed time in a in-limit memory and master storage memory.

Other features, aspects, and advantages of the above-described method and system will be apparent from the detailed description of the invention that follows.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a schematic block diagram of an embodiment of the present invention; and

FIG. 2 is a graphic representation of three cycles of temperature measurement using the apparatus depicted in FIG. 1;

FIG. 3 is a flowchart of a method of preparing the heating system to use the present invention; and

FIGS. 4A and 4B are a flow chart of a method of practicing the present invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been describe in detail so as not to obscure the invention.

The embodiment described herein includes an apparatus and method for collecting and analyzing temperature data that has been obtained from a heating system. The system and method described herein records temperature data remotely and measures, stores, and analyzes various operational parameters of the heating system with over the course of one or more heating cycles and with respect to the time rate of change of the measured temperature data. Because the system uses relative temperatures and elapsed time, the system does not need to be calibrated for temperature; it does not need to analyze exhaust gases; nor does it need to record absolute temperature or time data. The recorded time and temperature data are then compared to one or more predetermined parameters and a determination is made as to whether the heating system is functioning properly and efficiently.

As used herein the temperature sensor is a commercially available temperature sensor that may include a direct measurement, i.e., where the temperature sensor is in direct physical contact, or an indirect measurement, i.e., where the sensor is not in physical contact but rather senses temperature as a function of infrared or other radiation emitted by the stack or flue. The temperature, and if available time data, may be provided data via a wired or wireless link or via a wired or wireless data network such as an Ethernet, intranet, Internet, or other data communication network.

In the description that follows, it should be noted that the present invention does not require the temperature sensor be calibrated and does not require that the temperature sensor provide absolute highly accurate temperature data. As such, the present invention may be used on heating systems having widely varied temperatures and heating over widely varying periods. Thus, the present invention is able to be used on a wide variety of heating systems under a wide variety of conditions.

In general, a heating system should be properly maintained to acceptable industry standards by qualified service personnel who have the proper training, knowledge, and the necessary tools and instruments. This maintenance should be performed prior to making use of the present invention. Typically, this maintenance may include inspecting the furnace heat exchanger and removing any soot buildup. In addition, in forced hot air furnace systems, the furnace fan is thoroughly cleaned and the air filter replaced or cleaned. In a belt driven fan system, the motor is oiled and the belt tension checked. The burner is opened and cleaned and the motor and blower fan, if used, are cleaned and lubricated. If the burner nozzle is dirty, it should be replaced as well. In an oil fired system, the oil pressure in the burner is checked and all fittings are checked for leakage and the oil filter is checked and the cartridge replaced as necessary. Finally, the safety features, such as the high limit control and the cad cell flame cell, are checked and verified and repaired as needed. Other heating systems, such as natural gas, propane, kerosene, or any other fueled system, are maintained in well known and commonly practiced ways and methods.

Once the furnace has been cleaned and properly maintained, the furnace is then adjusted for maximum efficiency. In an oil furnace system, the system efficiency is maximized by four different measurements made through a pencil sized hole in the flue pipe close to the furnace. Once the furnace has been running for about 15 minutes and has reached a steady flue temperature, a sample of flue gases is taken and tested for smoke content and the draft pressure checked. Next the temperature and carbon dioxide and/or oxygen level of the flue gas is checked. Based on these measurements, the furnace may be adjusted and new measurements taken and the process repeated until the proper values, and therefore the maximum efficiency, is achieved. For a conventional oil-fired furnace manufactured over the past 30 years, the maximum allowable flue gas temperature was 400° C. The normal range of flue gas is typically between 175° C. and 280° C. where the lower the temperature of the flue gas, the more efficiently the furnace is running. Other furnace or heating systems using other fuel types will be adjusted for maximum efficiency using other methods well known in the art. Once the furnace has been adjusted, the setup data and other parameters are then recorded and stored for use by the present invention.

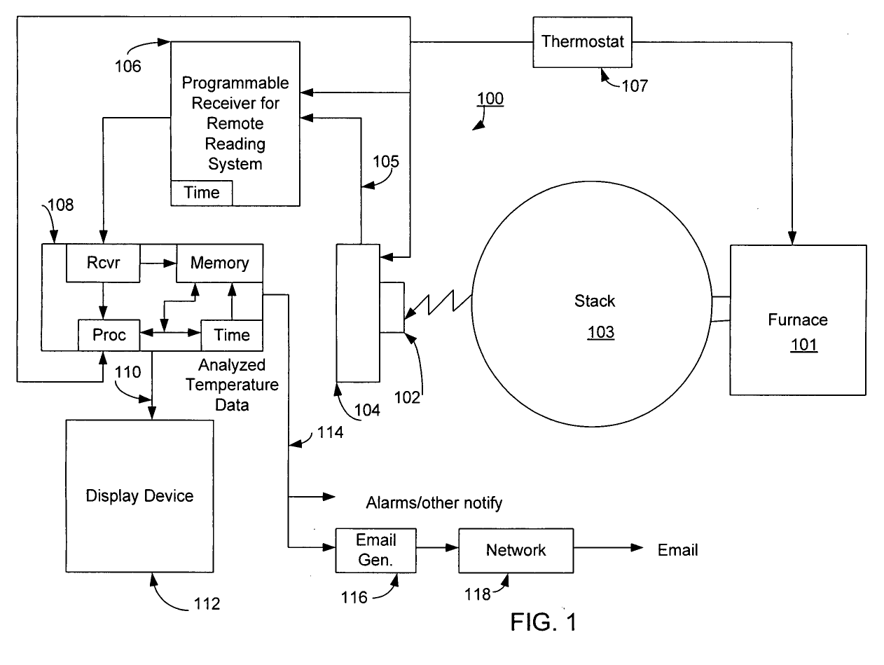

The system is depicted in FIG. 1. A thermostat 107 calls for a temperature adjustment and ignites a furnace 101 that provides exhaust gases to flue 103. The exhaust gases heat the flue 103 and the flue heats to a first temperature in a first period. A temperature sensor 102 is coupled to the flue 103 and senses the temperature of the flue 103. The temperature sensor 102, which may be turned on by thermostat 107, provides temperature data to a transfer module 104, that also may be triggered by thermostat 107, that formats the sensed temperature into a properly formatted temperature data signal 105 and transmits the properly formatted temperature data signal 105 to a programmable receiver 106, which may also be triggered by a temperature adjustment signal provided by thermostat 107. In one embodiment, the programmable receiver 106 may be for a remote sensing system and may be coupled directly to the temperature sensor transmitter 104 via a wired connection, wireless connection. The programmable receiver 106 may also be coupled to the thermostat 107 and be activated in response to a temperature adjustment signal provided by thermostat 107. In addition, the receiver 106 may receive the temperature data via a data network such as an Ethernet, company intranet, the Internet, World Wide Web or other data communications network.

A temperature analysis module 108 receives the temperature data signal form the receiver 106, decodes the temperature data and saves the temperature data in memory. The temperature analysis module 108 may be coupled to the thermostat 107 and be activated by a temperature adjustment signal provided by the thermostat 107. A time stamp is associated with the time the temperature data was recorded and stored may be saved in memory as well. The time stamp may be generated by the programmable receiver 106 or by the temperature analysis module 110. In another embodiment, the time stamp may be generated by the transfer module 104 and provided along with the properly formatted temperature data signal 105. As will be explained in more detail below, the important consideration is not the actual accurate time, but rather, the elapsed time between temperature measurements and ultimately the elapsed time period between the starting temperature and the maximum temperature reached by the flue 103. The temperature data and the associated time stamp data are provided to a processor for analysis.

It should be understood that the programmable receiver 106, the temperature analysis module 110, and the display device can be used to monitor a plurality of temperature sensors in remote locations. For instance, a central monitoring station may be used to monitor heating units in remote locations that are connected to the programmable receiver either by wired or wireless connections. In this embodiment, the data for each heating unit may be stored in individual files, managed by a database management system, or intermixed with other heating system data using added header data to identify the particular data. Moreover, it is envisioned that other types of sensors may be used as well. For instance, a combination of flue temperature, carbon monoxide, carbon dioxide, humidity, or room temperature may be monitored and stored as discussed above and analyzed as discussed in more detail below.

The processor can perform various analytical techniques on the temperature and time data. In a preferred embodiment, as discussed above, the setup information is saved and is stored in memory as base line data as well as allowable predetermined deviations for each of the various parameters. When the system thermostat 107 calls for a temperature adjustment, the temperature sensor data is recorded and the time and temperature data is provided to the temperature analysis module 108 where the processor is triggered and begins to analyze the time rate change of temperature data. The initial temperature of the flue 103 is recorded as the baseline temperature and as data is stored, the time rate of temperature change and the elapsed time from the baseline temperature are stored and in some instances displayed. A maximum temperature is reached, the actual value of which is not important; however, the time elapsed from the baseline temperature to the maximum temperature is important and is stored. After the maximum temperature is reached, the processor may discontinue storing data, may shut-off the temperature sensor itself and prevent data from being transmitted, or it may continue to record temperature data as the data falls from the maximum temperature back to the baseline temperature.

The next burner cycle, i.e., when the thermostat again calls for a temperature adjustment, the temperature sensor 102 and the processor store the temperature and time data and again calculate and store the time elapsed between the baseline temperature and the maximum temperature reached. The data associated with each heating cycle is considered to be a time-temperature data sample. This process continues until a desired number of time-temperature data samples have been stored in memory. At least a portion of the time-temperature data samples are then analyzed, individually or as aggregated data samples and compared to the predetermined deviation parameters. This comparison may include the elapsed time period that is required to reach the maximum temperature, the maximum temperature reached, or both of these parameters.

The comparison data is generated by the processor by calculating parameters between various data samples. The calculations may be done in a variety of ways that are well known in the art. In no way meant to be limiting, various statistics may be calculated using all of the data samples after all have been stored, or a portion of the data samples may be selected during the data collection process or only after all data samples have been stored. For example, an average or an average and standard deviation may be made over all of the data samples, a running average or a running average and running standard deviation may be calculated as the data is stored. In addition, the data may be filtered to remove unwanted artifacts from the data, e.g., by low pass filtering the data, or to emphasize the rise time of the temperature, e.g., by high pass filtering the data.

The comparison data is then compared to previously determined and stored comparison limits. In the event that the comparison data is within the previously determined comparison limits, the comparison data is recorded in a in-limits memory. In addition, a time stamp indicating the date and time corresponding to the comparison data may also be stored.

In the event that the comparison data is not within the previously determined comparison limits, the comparison data is recorded in a not-in-limits memory. In addition, a time stamp indicating the date and time corresponding to the comparison data may also be stored as well.

In the event that the comparison data is not within limits, an alarm or other notification may be activated. For example, a visual or audio alarm may be initiated or an email notification may be generated and sent. In addition, in some embodiments, it may not be beneficial to send an email, via a data network such as an Ethernet, intranet, Internet, World Wide Web, or other data communications network, or otherwise trigger an alarm after one or more out of limits events occurs. In these embodiments, a predetermined number of out of limit events must occur in sequence or a predetermined number of out of limit events must occur within a predetermined period of time before an alarm is set or an email generated and sent.

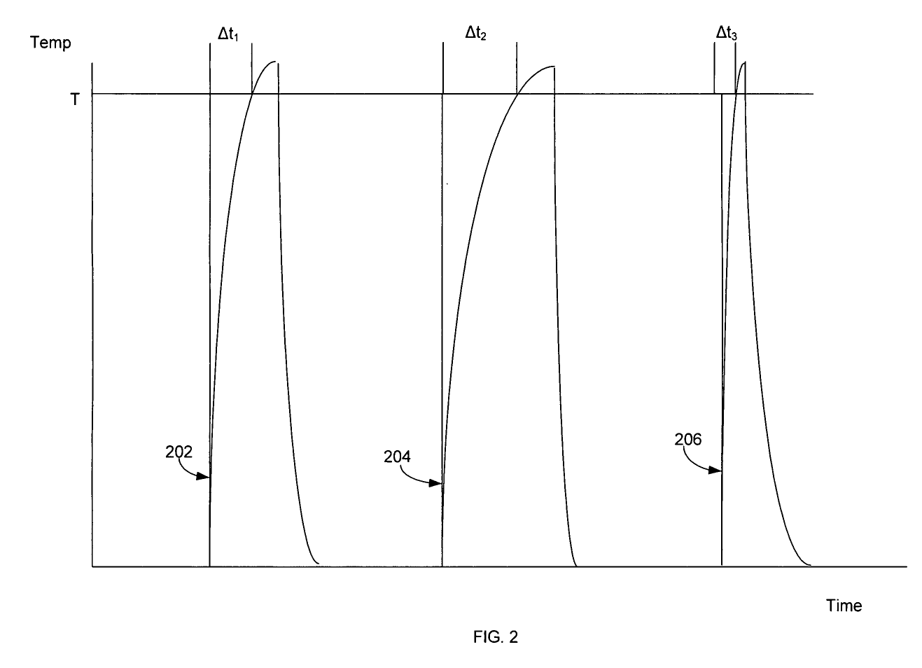

FIG. 2 depicts a graph of temperature vs. time illustrating the various curves for a furnace heating system. In particular, the graph 200 includes three time-temperature data samples that have been plotted in three curves, 202, 204, and 206. In each curve, a point is selected as the maximum temperature T and all analysis is based on this point. The time-temperature data samples are analyzed and the time difference between the baseline value and the maximum value T is determined, i.e., Δt₁, Δt₂, Δt₃. These values are determined, analyzed as discussed above to see if the furnace is running efficiently. For example, in curve 206, Δt₃ is quite small and is indicative that the stack temperature, i.e., the flue temperature, is rising quite rapidly and therefore too much heat is escaping in the stack and the furnace is running at a lower efficiency. Similarly, in curve 204, Δt₂ is quite large and is indicative that the stack temperature, i.e., the flue temperature, is rising quite slowly and therefore there may be an issue with the furnace preventing it from properly heating, which is also indicative that the furnace is running at a lower efficiency. Curve 202, being neither too slow nor too fast, is indicative of a properly adjusted furnace running at a high efficiency.

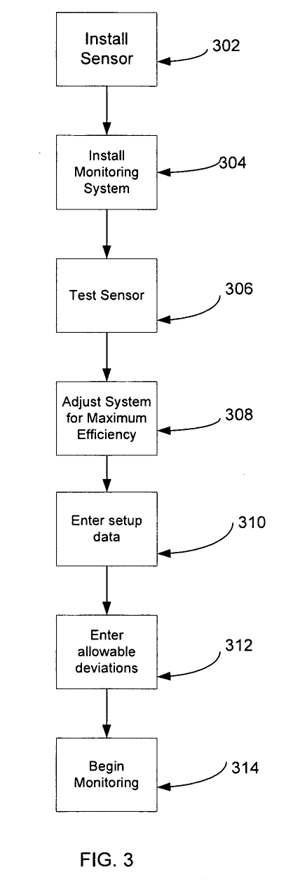

FIG. 3 is a flow chart for performing one aspect of the present invention. In particular, the method 300 includes, installing the temperature sensor, step 302, installing the monitoring system, step 304, and testing the sensor and communications, step 306. The monitoring system can be installed remotely from the furnace, as discussed above, where the temperature sensor is wirelessly connected to the monitoring system. The furnace system is adjusted for the maximum obtainable efficiency, step 308, the setup data and allowable deviations are entered into the monitoring system, steps 310, 312, respectively, and monitoring is begun, step 314.

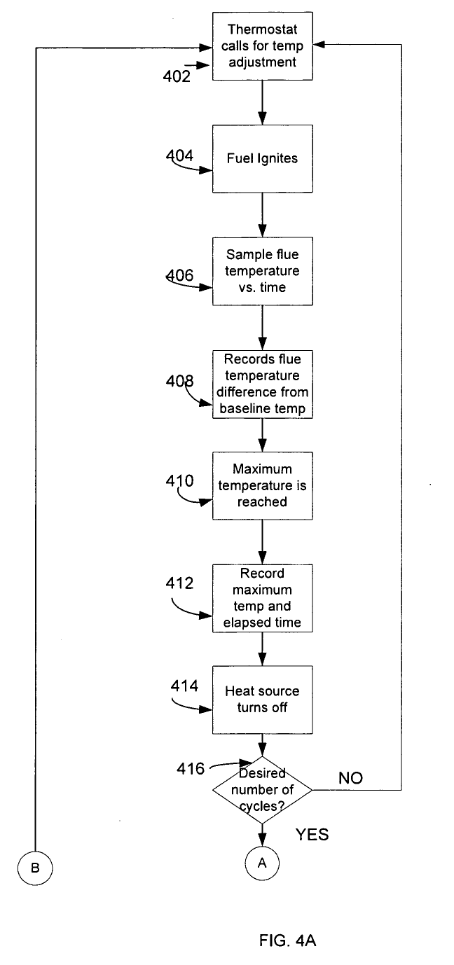

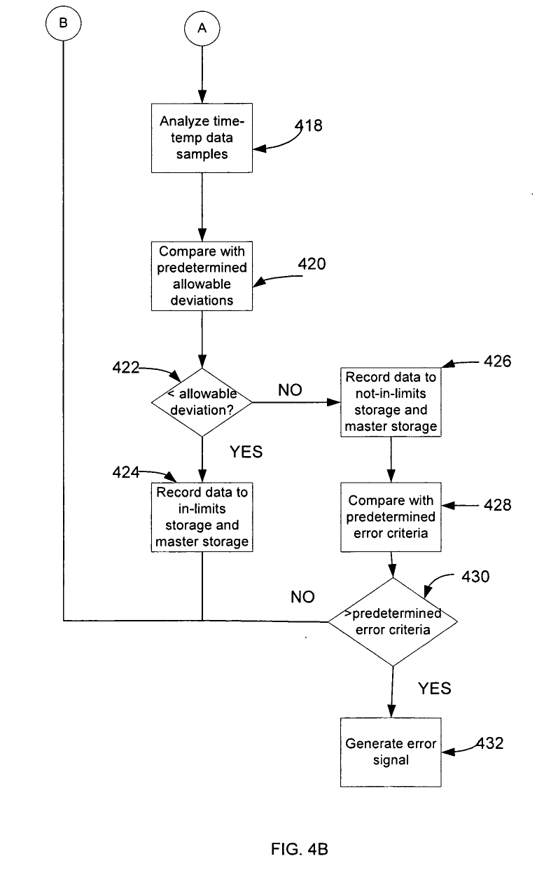

FIGS. 4a-4b depict a method for monitoring a furnace, i.e., step 314 above, according to an embodiment of the present invention. In particular, the monitoring begins when the thermostat calls for a temperature adjustment, step 402. The furnace ignites the fuel, step 404, and the temperature sensor is triggered by the thermostat and begins to monitor the stack temperature and record data, step 406. The temperature difference between the starting, i.e., the baseline, temperature is measured along with a time stamp, which may indicate the actual time or the time elapsed since the fuel was ignited, step 408. The maximum temperature is reached, step 410, and the maximum temperature difference between the baseline temperature and the maximum temperature is recorded along with the elapsed time, step 412, at which time the heat source turns off, step 414. Each cycle is recorded as a data sample and a predetermined number of data samples has been set, a check is made to see if the desired number of data samples have been recorded, step 416. If not enough data samples have been recorded, control returns to step 402 to await the next call by the system thermostat for a heat adjustment. If a sufficient number of data samples have been saved, control passes to step 418 where the data is analyzed. The analyzed data is compared to predetermined allowable deviations, step 420, and if the analyzed data is within limits, step 422, the data is recorded in an in-limits memory and also within the master storage memory as well, step 424. If the data is outside the predetermined deviations, the data is recorded in a not-in-limits memory, step 428, and the number of data recorded in the not-in-limits memory is checked and if the number is too high, step 430, an error signal is generated, step 332, or otherwise control returns to step 402.

It should be appreciated that other variations to and modifications of the above-described method and system for transferring and compressing medical image data may be made without departing from the inventive concepts described herein. Accordingly, the invention should not be viewed as limited except by the scope and spirit of the appended claims.

What is claimed is:

1. An apparatus for measuring the efficiency of a heating system including a flue and thermostat providing a temperature adjustment signal, the apparatus comprising:
a temperature sensor thermally coupled to the flue and operative to measure the external temperature thereof and to provide a plurality temperature data;
a receiver coupled to said temperature sensor and operative to receive said plurality of temperature data; and
a temperature analysis module coupled to said receiver and operative to receive said plurality of temperature data and to store said plurality of temperature data and a plurality of time data, each of said plurality of time data associated with a corresponding one of said plurality of temperature data forming a plurality of time-temperature data, said temperature analysis module further operative to analyze said time-temperature with respect to a predetermined limit and to provide an error alarm in the event that the time-temperature data exceeds said predetermined limit.

2. The apparatus of claim 1 wherein said receiver is coupled to said temperature sensor via a hard-wired connection.

3. The apparatus of claim 1 wherein said temperature sensor includes a wireless transmitter to format and transmit said plurality of temperature data as a plurality of wireless temperature data and said receiver is coupled to said wireless transmitter and is operative to receive said plurality of wireless temperature data.

4. The apparatus of claim 1 wherein said transmitter includes a time generator to provide an individual time stamp associated with each of said plurality of temperature data.

5. The apparatus of claim 1 wherein said receiver includes a time generator to provide an individual time stamp associated with each of said plurality of temperature data.

6. The apparatus of claim 1 wherein said temperature analysis module includes a time generator to provide an individual time stamp associated with each of said plurality of temperature data.

7. The apparatus of claim 1 wherein said temperature analysis module includes a processor operative to perform calculations and to manipulate said time-temperature data.

8. The apparatus of claim 1 wherein said processor is operative to perform statistical analysis.

9. The apparatus of claim 8, wherein the statistical analysis includes finding a mean and standard deviation.

10. The apparatus of claim 7, wherein said processor is operative to compare said a portion of said plurality time-temperature data to said predetermined limit to find if said portion of said plurality of time-temperature data exceeds said predetermined limit.

11. The apparatus of claim 1 further including a display device coupled to said temperature analysis module and operative to display said time-temperature data.

12. The apparatus of claim 1, wherein said error alarm includes a visual alarm.

13. The apparatus of claim 1, wherein said error alarm includes an audio alarm.

14. The apparatus of claim 1, wherein said error alarm includes generating an email and sending said email to a predetermined email address.

15. The apparatus of claim 1 wherein said temperature sensor directly senses the temperature of the stack.

16. The apparatus of claim 1 wherein said temperature sensor indirectly senses the temperature of the stack.

17. The apparatus of claim 16 wherein said indirect measurement includes measuring infrared emissions from the stack.

18. The apparatus of claim 7, wherein said processor is a microprocessor.

19. The apparatus of claim 1, wherein said temperature sensor is coupled to the thermostat and is responsive to said temperature adjustment signal to begin to provide a plurality temperature data;

20. The apparatus of claim 1 wherein said receiver is coupled to said thermostat and coupled to said temperature sensor and is responsive to said temperature adjustment signal operative to begin receive said plurality of temperature data.

21. The apparatus of claim 1 wherein said temperature analysis module is coupled to said thermostat and coupled to said receiver and is responsive to said temperature adjustment signal to begin to receive said plurality of temperature data and to store said plurality of temperature data and a plurality of time data, each of said plurality of time data associated with a corresponding one of said plurality of temperature data forming a plurality of time-temperature data, said temperature analysis module further operative to analyze said time-temperature with respect to a predetermined limit and to provide an error alarm in the event that the time-temperature data exceeds said predetermined limit.

22. A method for measuring the efficiency of a heating system including a flue and thermostat. The method comprising:
(a) detecting the heating system turning on;
(b) sensing the temperature of the flue and providing temperature data;
(c) recording the temperature data and a time data associated with said temperature data to form time-temperature data;
(d) detecting the maximum temperature of the flue;
(e) recording the maximum temperature;
(f) determining the elapsed time from the heating system turning on until the maximum temperature was reached;
(g) recording the elapsed time associated with the maximum temperature;
(h) comparing the elapsed time and maximum temperature with a predetermined limit;
(j) in the event that the elapsed time, the maximum temperature, or both exceed the predetermined limit, record the maximum temperature and elapsed time in a not-in-limit memory and master storage memory;
(k) compare the number of entries in the not-in-limit memory and compare to a predetermined limit;
(l) in the event that the number of entries in the not-in-limit memory exceeds the predetermined limit, generate an error signal; and
(m) in the event that neither the elapsed time or the maximum temperature exceed the predetermined limit, record the maximum temperature and elapsed time in a in-limit memory and master storage memory.

23. The method of claim 22, wherein the error signal is an audio alarm.

24. The method of claim 22, wherein the error signal is a video alarm.

25. The method of claim 22, wherein the error signal is an email that is generated and sent to predetermined email address.

26. The method of claim 22 repeating steps (a)-(m).
